(19) United States
(12) Patent Application Publication
(10) Pub. No.: US 2002/0147919 A1
(43) Pub. Date: Oct. 10, 2002

(54) Secured delivery system for unattended receiving and shipping of parcels and letters

(76) Inventor: Daniel W. Gentry, Oklahoma City, OK (US)

Correspondence Address: Arthur I. Navarro, Navarro IP Low Group, Suite 655, 801 E. Campbell Rd., Richardson, TX, 75081, US

(21) Appl. No.: 09/776,525

(22) Filed: Feb. 3, 2001

(51) Int. Cl. H04L 9/00

(52) U.S. Cl. 713/200

(57) ABSTRACT

In a secure delivery system (8) for unattended delivery of parcels and letters, customer profile information (15) is accessed through a web page (18) to provide a delivery service (12) with information for the location and code (17) to access a tamper-proof enclosure (10). Tamper-proof enclosure (10) is linked to information in the customer profile information (15). In addition, Tamper-proof enclosure (10) is capable of sending a status message (19) through a transmitter (32) to a routing hub (16) when deliveries are made.

### FIELD OF THE INVENTION

This invention relates in general to the safe delivery, storage, and protection of parcels and letters. More particularly, the invention relates to a tamper-proof enclosure and delivery system which allows for unattended delivery and receipt of parcels and letters by a customer.

### BACKGROUND OF THE INVENTION

Without limiting the scope of the invention, its background is described in connection with the delivery of private carrier letters and packages, as an example.

Modern retailing relies heavily on direct delivery for goods and services in the consumer market and the business-to-business market. As other types of retailing are used, besides traditional brick and mortar stores, direct delivery of goods is becoming more common. Until recently, goods were normally purchased in a store and the consumer carried the goods out of the store, the exception being large articles of furniture or other large and unwieldy goods. Large and unwieldy goods require a larger than normal vehicle for transportation or specialized installation and delivery skills.

Today, when goods are purchased through the Internet, catalogs, or other means of mail order, it is always a problem to get the goods delivered. Most delivery services prefer to have a person sign for the delivery. However, with today's busy schedules, most homes are unoccupied during the day.

When nobody is home, the delivery service must either make repetitive trips to try to find someone at the location or request that the consumer travel to a delivery station to pick up the package. Sometimes, the delivery service leaves the package at a neighbor's house or on the doorstep or some other unsecured location.

At the same time, it is inconvenient and costly for the delivery company to make repetitive trips to deliver a package. Additionally, it is inconvenient for the consumer to have to take off work or make a trip to the delivery service's office. Just delivering the packages to an unattended door or other location around the house is not secure and provides many opportunities for the package to become lost, stolen, or damaged. Many delivery companies leave packages unattended simply because it is cheaper for them to leave the package unattended than to bother with trying to properly deliver it.

Accordingly, a need exists for a secure delivery system which is convenient for both the delivery service and the consumer. A means of secure, unattended delivery of parcels and letters would provide numerous advantages.

### SUMMARY OF THE INVENTION

The present invention provides a secure delivery system for unattended receiving and shipping of parcels and letters. With the present invention, a person may confidently order goods over the Internet, from catalogs or other mail order methods and be sure that their package will be safely delivered.

Accordingly, disclosed in one embodiment is a system allowing a customer to place an order with the retailer and to have a delivery service deliver the goods to a tamper-proof enclosure. When the goods are placed in the enclosure, a status message is sent to a routing hub and then to the customer who placed the order. The delivery service gains access information to the enclosure from an Internet-based application (such as a web page) accessible through the Internet. The application contains customer profile information which allows the delivery service to operate the enclosure.

Disclosed in another embodiment is a secure shipping system for unattended shipping of parcels. The customer places the parcel in a tamper-proof enclosure, then the customer notifies the delivery service that a parcel is to be picked up. The delivery service obtains the customer profile information from a web page with the customer profile including a code to open the tamper-proof enclosure. The delivery service picks up the package from the tamper-proof enclosure and ships the package on to its destination.

In one embodiment, the secure delivery system includes a transmitter to send status messages to a receiver at a routing hub. The routing hub forwards the status message via email, to a web page, or by other similar means to the customer and the delivery service.

Also disclosed is a tamper-proof enclosure for the unattended receiving and shipping of parcels and letters. The enclosure is a box with an open side. The open side is covered by an electronically locked door. The door substantially closes the open side of the box and is held securely in place by a lock. The enclosure also includes a means for sending a status message.

A technical advantage of the present invention is the ability to securely deliver an unattended package or parcel. Thus the package is not subjected to damage or theft and the customer does not have to be present to receive the delivery.

Another technical advantage of the present invention is the ability to receive a status message when the package is delivered or picked up so the customer is aware that the delivery service has made its delivery.

### BRIEF DESCRIPTION OF THE DRAWINGS

For a more complete understanding of the present invention, including its features and advantages, reference is made to the following detailed description of the invention, taken in conjunction with the accompanying drawings of which:

FIG. 1 is a flow diagram of a secure delivery system for the unattended receiving of parcels and letters, according to the invention;

FIG. 2 is a flow diagram for a secure delivery system for shipping of parcels and letters, according to one embodiment of the present invention;

FIG. 3 depicts a tamper-proof enclosure, according to one embodiment of the present invention;

FIG. 4 illustrates a remotely controlled tamper-proof enclosure, according to one embodiment of the present invention;

FIG. 5 illustrates a tamper-proof enclosure installed in a building, according to one embodiment of the present invention;

FIG. 6 is a front view of a tamper-proof enclosure installed in a wall, according to one embodiment of the present invention;

FIG. 7 is a side view of a tamper-proof enclosure installed in a wall, according to once embodiment of the present invention;

FIG. 8 depicts a tamper-proof enclosure with dual doors, according to one embodiment of the present invention;

FIG. 9 illustrates a tamper-proof enclosure with two compartments according to one embodiment of the invention; and

FIG. 10 is a flow diagram that illustrates a method of delivery according to one embodiment of the present invention.

Corresponding numerals and symbols in the figures refer to corresponding parts in the detailed description unless otherwise indicated.

### DETAILED DESCRIPTION

While the making and using of various embodiments of the present invention are discussed in detail below, it should be appreciated that the present invention provides many applicable inventive concepts which can be embodied in a wide variety of specific contexts. These specific embodiments discussed herein are merely illustrative of specific ways to make and use the invention, and do not delimit the scope or the application of the invention.

Referring to FIG. 1, therein is shown a diagram for a secure delivery system 8 for receiving parcels and letters. Customer 14 places an order with retailer 22 and provides a link to an Internet-based application. In one embodiment, Internet based application is a web page 18 which is used to access customer profile information 15. Customer profile information 15 includes the location and address of the customer 14, the customer's name, a code 17 for operating a tamper-proof enclosure (discussed below) and the location of the tamper-proof enclosure. The customer profile information 15 is held in a means for storing a plurality of customer profile information, typically in a computer database. Retailer 22 then ships the order to a delivery service 12 including information regarding the web page 18 and the customers profile 15. The delivery service 12 then ships the goods to tamper-proof enclosure 10 using the data in customer profile information 15.

When the goods are placed in tamper-proof enclosure 10, a status message 19 is sent to routing hub 16 and then forwarded to customer 14. Status message 19 may optionally be sent to the retailer 22 or delivery service 12. Delivery service 12 uses a code 17 provided from web page 18 to open tamper-proof enclosure 10. Thus, delivery service 12 is able to leave the goods in a secure place accessible to customer 14.

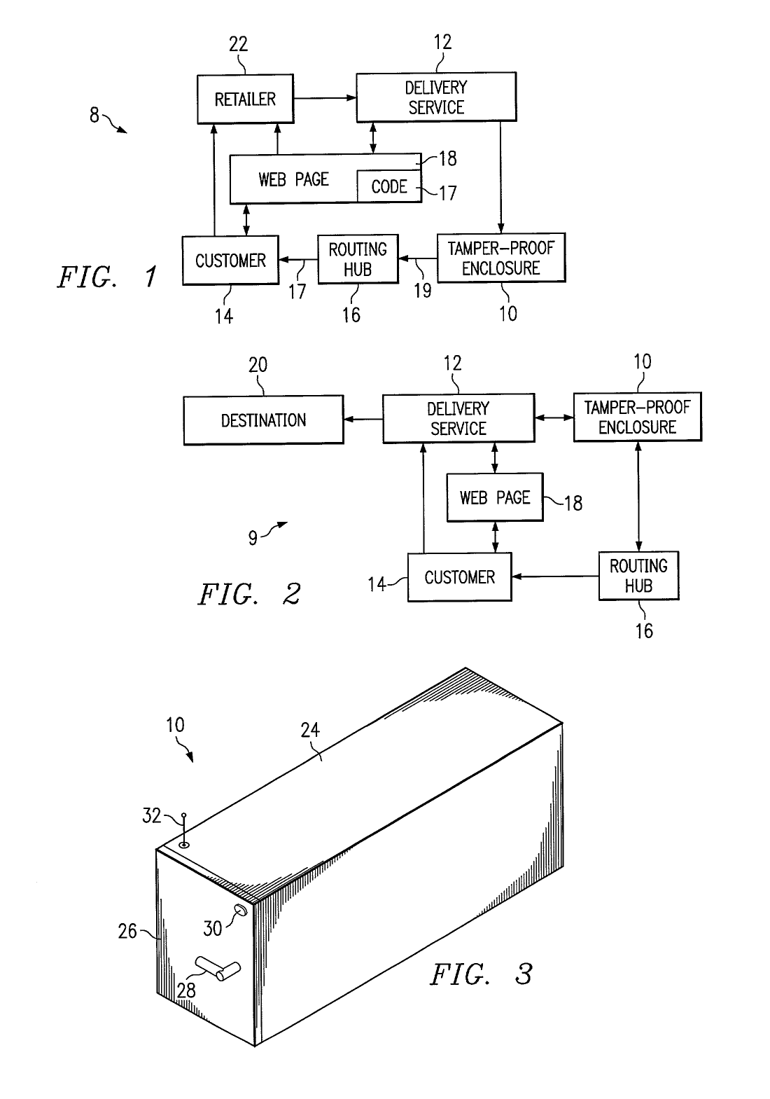

FIG. 2 illustrates use of secure delivery system 8 for shipping a parcel. Customer 14 contacts delivery service 12 and notifies them of the need to pick up a parcel from tamper-proof enclosure 10 and also provides a link to the web page 18. Web page 18 is the Internet-based application used to gather and store customer profile information 15 such as, for example, the address, the code 17 for the tamper-proof enclosure 10 and the location of the tamper-proof enclosure. In additional embodiments of the invention, the customer profile information 15 also contains shipping account information or credit account information to pay for services and goods. Delivery service 12 then arrives at tamper-proof enclosure 10 using the code 17 provided from web page 18 and opens the tamper-proof enclosure 10 and removes the package to ship it to destination 20. When the tamper-proof enclosure 10 is open, routing hub 16 receives a status message 19 from tamper-proof enclosure 10 and forwards the status message 19 to customer 14. Thus, customer 14 is aware that the package has been picked up by delivery service 12 and is on its way to its destination 20. In another embodiment, tamper-proof enclosure 10 may also provide a status message 19 to routing hub 16 if the tamper-proof enclosure 10 is tampered with or disturbed.

FIG. 3 shows a tamper-proof enclosure 10, according to one embodiment of the present invention. Tamper-proof enclosure 10 is a box 24 with one open side which is covered with a door 26. Door 26 is shown shut and may be opened with a handle 28. Tamper-proof enclosure 10 may also be remotely controlled and opened with a remote control through an infrared port 30. Tamper-proof enclosure 10 further includes a means for sending a status message in the form of a transmitter 32 which is capable of sending a status message 19 to the routing hub 16. Those skilled in art will recognize that transmitter 32 may also be a transceiver if two way messaging is desired to remotely control the operation of tamper-proof enclosure 10. Tamper-proof enclosure 10 has a means for processing (not shown), for example a microchip, to store and validate code 17. In addition, the processing means acts as a brain to coordinate the sending and receiving of status messages 19 and other similar actions.

The tamper-proof enclosure 10 may be any size and will typically be produced in several different sizes so that a consumer may pick a size which is most appropriate for their needs. Typical consumer sizes would be up to approximately 3 feet in length, depth and height. A business may need a very large tamper-proof enclosure 10, thus tamper-proof enclosure 10 may be a room of a building or even an entire building, such a warehouse. A preferred embodiment of the invention uses approximately two inch thick durable hard plastic for the box 24 and the door 26 of tamper-proof enclosure 10. The thick plastic would make tamper-proof enclosure 10 difficult to move or break into. Alternatively, tamper-proof enclosure 10 could be made from metal, concrete or other suitable materials known to those skilled in the art. Those skilled in art will recognize that power for tamper-proof enclosure 10 may be provided from a standard 110 Volt AC electrical outlet, batteries, solar cells, or other means of power.

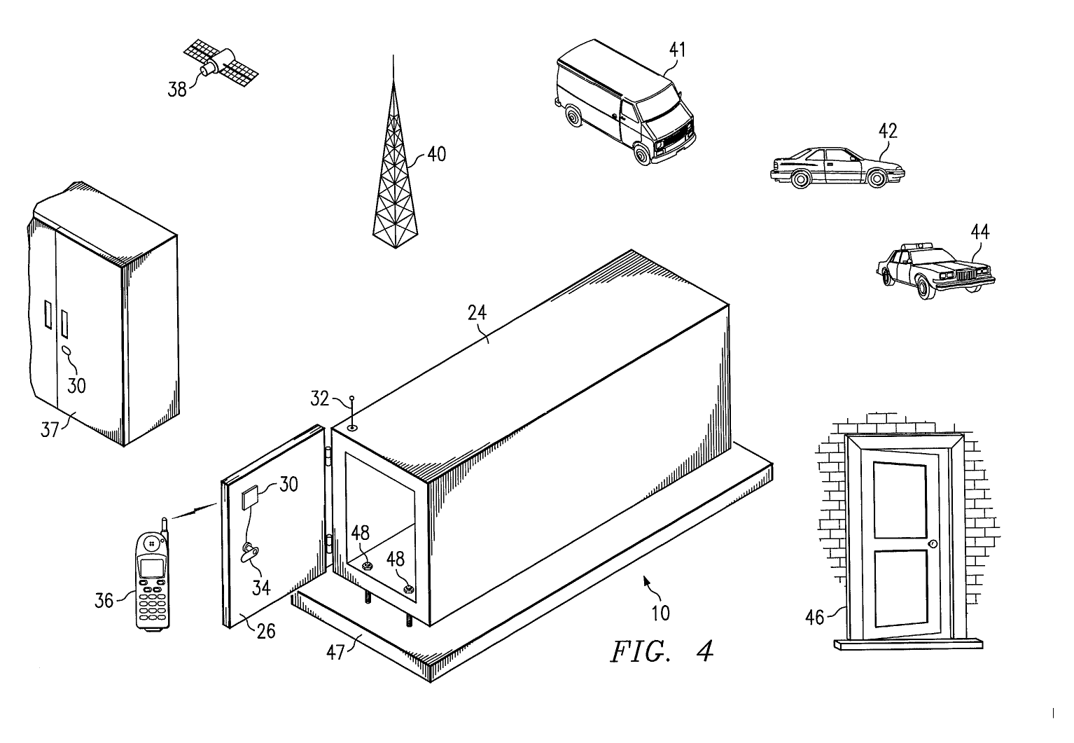

FIG. 4 illustrates tamper-proof enclosure 10 and the many features which it supports. As shown, tamper-proof enclosure 10 has two bolts 48 which function as means for attachment to secure tamper-proof enclosure 10 to a foundation. Thus, tamper-proof enclosure 10 may be securely fastened so that a thief or other person cannot simply pick up tamper-proof enclosure 10 and remove tamper-proof enclosure 10 and its contents. The preferred embodiment of the invention will secure tamper-proof enclosure 10 to a foundation 47. The foundation 47 will typically be a concrete pad.

Remote control 36 is shown as a mobile telephone and includes the ability to receive status message 19 and to transmit an infrared signal to the infrared port 30 on tamper-proof enclosure 10. Thus, remote control 36 functions as a mobile telephone and a security device capable of unlocking tamper-proof enclosure 10 with an infrared signal. Although an infrared link is used to communicated the code 17 to electronic lock 34, those skilled in the art will appreciate that this link could also be carried over radio frequencies, fiber optics, manually or by other similar means. Remote control 36 is used to program the code 17 to unlock tamper-proof enclosure 10. The code 17 is then updated in the customer profile information 15 by a status message 19 sent through the routing hub 16. The phone capabilities allow for the remote control 36 to receive status message 19 from the routing hub 16 as email, voice mail, web pages, or other similar means.

Another feature of remote control 36 is its ability to receive a messaging signal from personal vehicles 42. If personal vehicles 32 are stolen or otherwise tampered with, a status message 19 is sent to the remote control 36 notifying the owner of problems with the vehicle. Remote control 36 also controls a signal to call 911 or other emergency services so that police 44 will be notified. Thus, if personal vehicles 42 are discovered to be tampered with via their communication link, remote control 36 can be used to send the police 44. Also, if the tamper-proof enclosure 10 is tampered with, its transmitter 32 will send a status message 19 to remote control 36 and the police 44 will be dispatched directly. Remote control 36 can also be used to unlock doors 46 or windows on homes or offices and control suitably equipped electrical appliances. In one embodiment, each door or window is assigned a unique identity, such as an identity number, so that status message 19 would notify remote control 36, police 44 and satellite 38 as to which door or window has been disturbed. In addition to exterior doors and windows, interior doors may also be equipped with the invention. The ability to determine which doors or windows have been disturbed allows the police 44 to easily locate an intruder in a building. Status message 19 may also include a time and date stamp to indicate when tamper-proof enclosure 10 was accessed. In addition, a registration number identifying the specific remote control 36 accessing tamper-proof enclosure 10 may be sent in status message 19 in an alternative embodiment.

In another embodiment, remote control 36 is configured for use by a delivery service 12. Remote control 36 has a micro-chip capable of downloading the codes 17 for all of the tamper-proof enclosures 10 from the routing hub 16. When remote control 36 opens a tamper-proof enclosure 10, a status message 19 is sent by either remote control 36 or tamper-proof enclosure 10 to the routing hub 16, customer 14, and retailer 22 notifying that the delivery has occurred.

In additional embodiments, tamper-proof enclosure 10 is incorporated into a refrigerated unit, such as a refrigerator 37. Refrigerator 37 has an infrared port 30 which can be used to unlock refrigerator 37. Thus, a grocery delivery company may safely leave perishable groceries by placing them in refrigerator 37. Because of a lock 34 accessed through infrared port 30, the grocery delivery company may access refrigerator 37 but others will not be able to open refrigerator 37. The customer 14 and the grocery store may receive a status message 19 notification that a delivery has been made to refrigerator 37. Status message 19 may originate from either remote control 36 or refrigerator 37.

The tamper-proof enclosure 10 may be used as part of a secure delivery system using satellite communications. Remote control 36 or a satellite-based computer system is capable of directly communicating with satellite 38. The components of tamper-proof enclosure 10 may also be used in other types of devices such as doors 46, windows, appliances, or vehicles. By assigning a different code 17 to each device, remote control 36 can show the status of each device and operate each device independently. Each device such as car 42, refrigerator 37, tamper-proof enclosure 10, door 46 and other uses known to those skilled in the art is assigned a unique identity. For example, a different identity number is assigned to each device in the system. Each device has appropriate system components such as infrared port 30, lock 34, and a transceiver capable of communicating with satellite 38. Remote control 36 can send a code 17 through satellite 38 to unlock a door on a tamper-proof enclosure 10, a door to a building, a door to car 42, turn the ignition on or off on car 42, operate an appliance such as a lamp, or perform other operations. The system has software to allow remote control 36 to display the status of each device. Each device sends and receives status messages 19 through satellite 38. Satellite 38 is able to communicate directly with the Internet so that status messages 19 are also sent and received from email accounts and web pages to devices in the system.

Individual identity numbers on each device allow for precise tracking of problems such as a burglary or other unauthorized entry. Specifically, by placing an identity number on each door in a building, the police 44 could use a map display on remote control 36 to determine the location of a burglar in a building by the movement of doors equipped as part of the system. This would make the building search safer for a police officer. In a building such as a home or office, doors 46 and windows would be part of the system. In a vehicle, such as a car 42 or a truck, the doors, windows, hood, and truck would typically be equipped as part of the system.

In one embodiment, remote control 36 has Internet access. The Internet access will allow the user to place an order for merchandise with retailer 22. Delivery service 12 then delivers the merchandise from retailer 22 to the user's tamper-proof enclosure 10. Remote control 36 can access the Internet via satellite 38 or by other methods known to those skilled in the art.

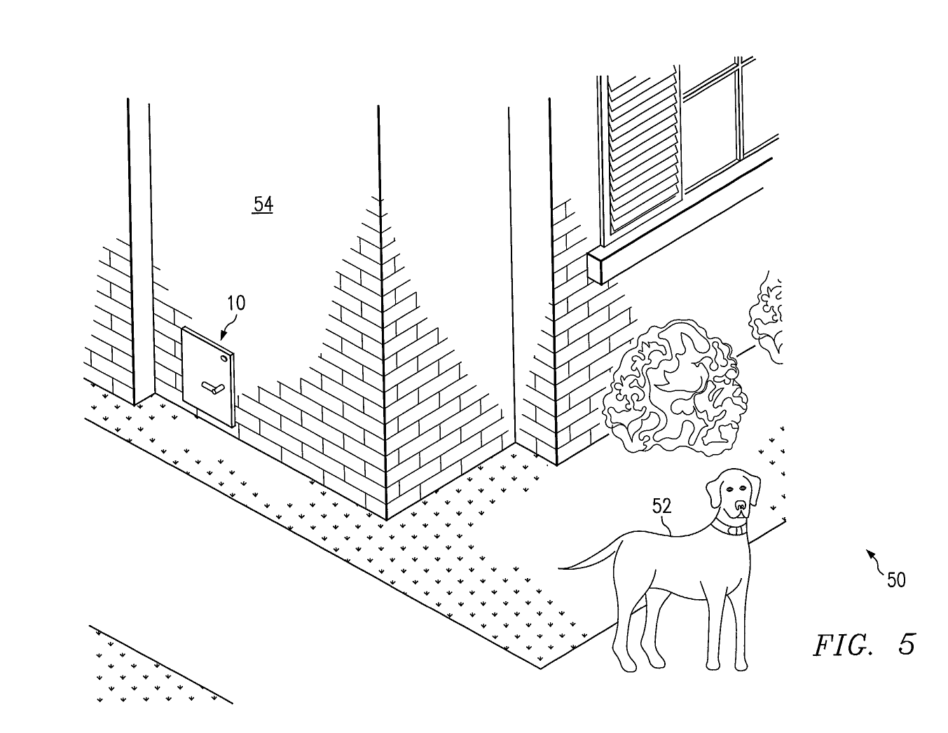

In FIG. 5, tamper-proof enclosure 10 is shown installed in building 50. In this embodiment, the customer profile information 15 contains information about the address of the house, the customer's name and the location at the address of the tamper-proof enclosure 10. The customer profile information 15 can also contain other information such as the name of a dog 52. Thus, the delivery service personnel can know that there is a dog 52 on the premises, whether the dog 52 is vicious or friendly, and the name of the dog 52 so that they can talk to the dog and make the dog 52 more comfortable with their presence. Unexpectedly startling even a friendly dog 52 is one of the most dangerous parts of a delivery persons job. An otherwise good natured dog 52 may attack when surprised. However, if the delivery person is aware of the dog 52, the delivery person can find the dog 52 and make sure the dog 52 seems friendly before approaching. Delivery personal commonly use treats such as bones or dog biscuits to occupy a dog 52 while making a delivery.

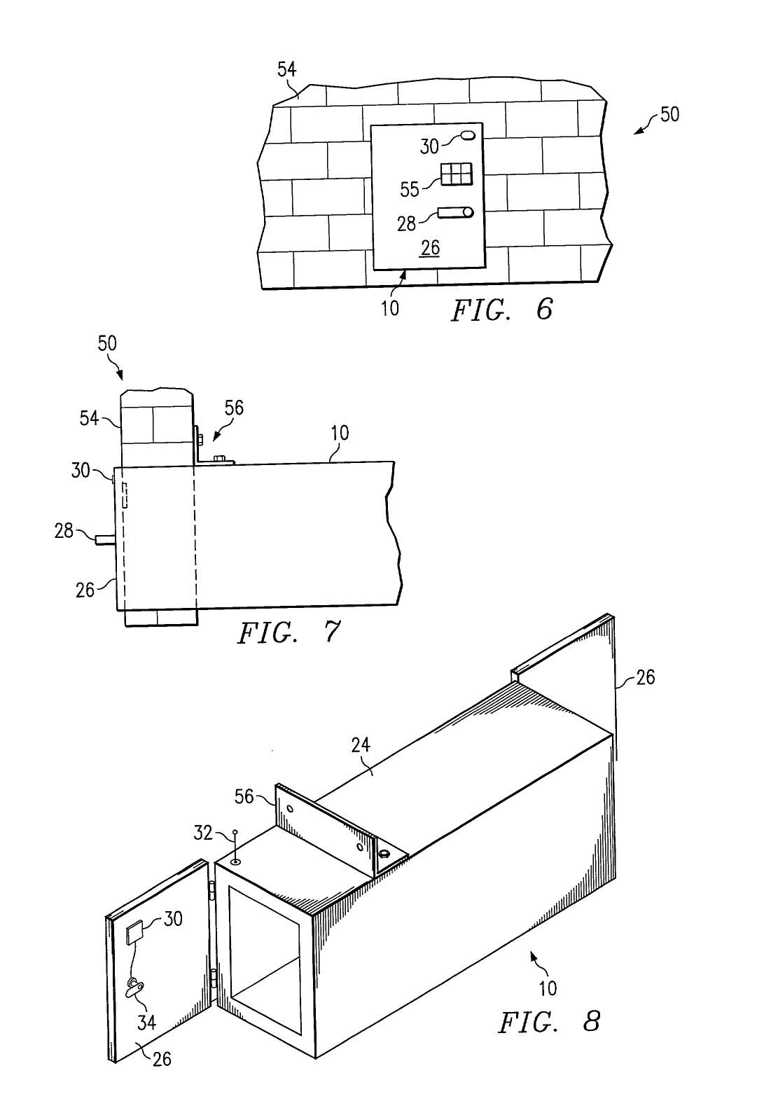

FIG. 6 is a front view of tamper-proof enclosure 10 installed in wall 54 of building 50. Door 26 is flush with the wall 54 and is opened by handle 28. Door 26 is unlocked via infrared port 30. In addition, control pad 55 may also be used to unlock door 26, by entering a code 17 through control pad 55.

FIG. 7 is a side view of tamper-proof enclosure 10 installed in wall 54 in building 50. Flange 56 is built into tamper-proof enclosure 10 and attached to wall 54 so that tamper-proof enclosure 10 is securely attached to wall 54 and is not easily removed from wall 54. Flange 56 can be built into wall 54, bolted to wall 54, or attached by other similar means. This allows tamper-proof enclosure 10 to be a secure and integral portion of building 50 and makes it very difficult for a thief to remove tamper-proof enclosure 10. In alternative embodiments, tamper-proof enclosure 10 is free standing within a room, built into a wall within a room, or built into the floor within a room. In these alternative embodiments the tamper-proof enclosure may optionally be accessible from one or more openings. The features of tamper-proof enclosure 10 may optionally be included in a bank safety deposit box, a commercial safe, a residential safe or other similar security apparatus.

FIG. 8 is an illustration of tamper-proof enclosure 10 having two doors 26. A door 26 is placed on each end of box 24. By placing a door 26 at each end of tamper-proof enclosure 10, tamper-proof enclosure 10 may be installed in wall 54 and access may be gained to tamper-proof enclosure 10 from either the outside or the inside of the building 50. This is useful for relieving the customer 14 from having to make a trip outside to gain access to the goods delivered in tamper-proof enclosure 10. The ability to access tamper-proof enclosure 10 from inside of building 50 is a especially useful in cold, hot, or wet climates, since the customer 14 and the package are protected from the weather.

Tamper-proof enclosure 10 has a lock 34 which is unlocked by accessing infrared port 30 with a code 17 from remote control 36. A remote control 36 may be built into other objects such as a personal digital assistant, a key ring similar to those used for unlocking automobiles, or other similar devices. When a package is placed in tamper-proof enclosure 10, a status message 19 is sent by transmitter 32 to routing hub 16 and the customer 14 is notified of the delivery. Routing hub 16 will use email, voice mail, or other means known to those skilled in the art to forward the status message 19 to customer 14.

In addition to securing tamper-proof enclosure 10, lock 34 may be used to secure a motor vehicle. Lock 34 could be used to secure the doors, trunk, fuel door, the fuel tank, the hood, or other parts of a vehicle needing to be secured. In addition, remote 36 is used to unlock the ignition to stop and start a motor in an alternate embodiment.

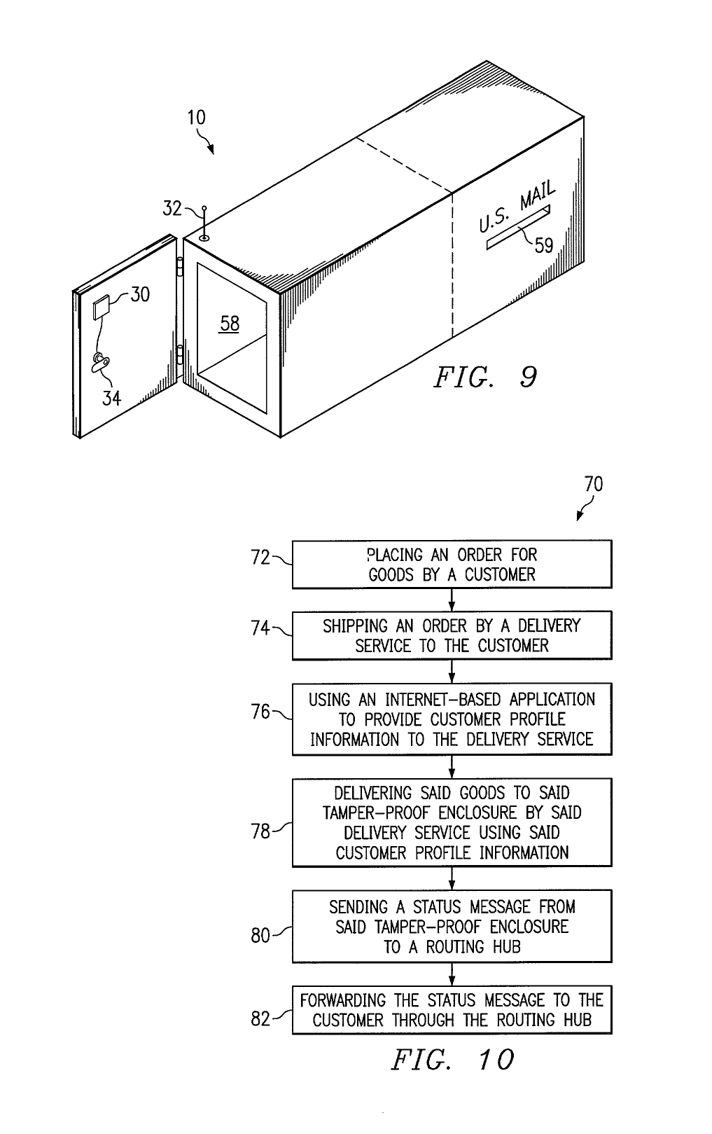

Illustrated in FIG. 9 is an embodiment of the present invention of tamper-proof enclosure 10 with two compartments. Tamper-proof enclosure 10 has an over size compartment 58 and a U.S. Mail compartment 59. Oversize compartment 58 is used for large pieces of mail and by delivery services 12 other than the U.S. Postal Service. Other delivery services 12 include United Parcel Service (UPS), Federal Express (FEDEX), Airborne Express, direct business to business, intra-company deliveries, and others. U.S. Mail compartment 59 is for the routine delivery of mail. Those skilled in the art will appreciate that U.S. mail compartment 59 must meet the requirements of the U.S. Postal Service to be approved for receiving deliveries from the U.S. Postal Service.

FIG. 10 illustrates the method for using a secure delivery system 70, according to the invention. At step 72, an order for goods is placed by a customer 14 to be delivered by a delivery service 12. A customer 14 contacts a retailer 22 to place an order for certain goods. In step 74, these goods are then sent from the retailer 22 to a delivery service 12. Delivery service 12 will take the goods from retailer 22 to customer 14. In step 76, delivery service 12 accesses an Internet based application which contains the customer profile information 15. Delivery services 12 needs the customer profile information 15 to know where tamper-proof enclosure 10 is located and for the code 17 to open tamper-proof enclosure 10.

Next, in step 78, delivery service 12 delivers the goods to customer 14 by placing the goods in tamper-proof enclosure 10. Typically, delivery service 12 uses a remote control 36 to send the code 17 to the tamper-proof enclosure 10 to unlock door 26. Next, in step 80, a status message 19 is sent to routing hub 16 to confirm the delivery of the goods by delivery service 12. Finally, in step 82 a status message 19 is forwarded to the customer through the routing hub 16. In alternative embodiments, a status message 19 is forwarded to delivery service 12 to confirm delivery in tamper-proof enclosure 10 at the customer 14 location. This is much more secure than the current method of a delivery service 12 leaving a package on a front door unattended or leaving it with a neighbor. The invention provides for much more convenient delivery of parcels since the delivery is made without delay or with out the customer 14 having to go the delivery service office.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. It is, therefore, intended that the appended claims encompass any such modifications or embodiments.

What is claimed is:

1. A secure delivery system for unattended delivery of an order to a customer comprising:
a tamper-proof enclosure having at least one opening operably controlled using a customer specified code; and
an Internet-based application accessible by both a customer and one or more delivery services and providing a means for storing a plurality of customer profile information, said information providing a specified delivery service with a means of obtaining said specified code so that said specified delivery service can operate said tamper-proof enclosure;
wherein an order placed by said customer can be delivered to said tamper-proof enclosure by said specified delivery service using said specified code.

2. The system of claim 1 wherein said customer profile information contains a name and an address of said customer.

3. The system of claim I wherein said customer profile information contains a location of said tamper-proof enclosure.

4. The system of claim 1 further comprising a routing hub for routing a status message about said tamper-proof enclosure.

5. The system of claim 4 wherein said routing hub transmits said status messages about said tamper-proof enclosure to said customer.

6. The system of claim 4 wherein said routing hub transmits said status messages about said tamper-proof enclosure to said specified delivery service.

7. The system of claim 4 wherein said routing hub transmits said status messages to a web page.

8. The system of claim 4 wherein said tamper-proof enclosure further comprises a transmitter to send said status messages.

9. The system of claim 8 wherein said routing hub further comprises a receiver to receive said status messages from said transmitter.

10. The system of claim 9 wherein said receiver and said transmitter communicate through a satellite.

11. The system of claim 1 wherein said tamper-proof enclosure further comprises a remote control to send said specified code to said tamper-proof enclosure.

12. The system of claim 4 wherein said routing hub can send said status messages via an email message to said customer.

13. A tamper-proof enclosure for secure and unattended receipt and shipping of goods comprising:
a box having a least one opening;
an electronically locked door which opens to permit access to contents within the box and closes to cover said opening and protect said contents within the box; and
a means for processing within said box adapted for creating and storing a specified code;
wherein said door is opened by use of said specified code.

14. The tamper-proof enclosure of claim 13 further comprising a control pad operably accessible from outside said box and linked to said processing means, said control pad configured to allow entry of codes into said processing means.

15. The tamper-proof enclosure of claim 13 further comprising means for sending a status message.

16. The tamper-proof enclosure of claim 15 wherein said means for sending a status message is a transmitter.

17. The tamper-proof enclosure of claim 13 further comprising a infrared communication port communicably linked to said means for sending a status message.

18. The tamper-proof enclosure of claim 17 further comprising a remote control device capable of communicating with said means for sending a status message.

19. The tamper-proof enclosure of claim 18 wherein said remote control device transmits said specified code through said infrared communication port to unlock said lock.

20. The tamper-proof enclosure of claim 13 wherein said box further includes a means for attachment to a foundation.

21. The tamper-proof enclosure of claim 20 where in said attachment means is at least one bolt securing said box to a foundation.

22. The tamper-proof enclosure of claim 13 further comprises at least one flange extending from said box to allow said tamper-proof enclosure to be built into a building.

23. The tamper-proof enclosure of claim 13 wherein said box further comprises a refrigeration unit to control the temperature within said box.

24. The tamper-proof enclosure of claim 13 wherein said box is divided into two or more compartments.

25. The tamper-proof enclosure of claim 23 wherein one of said compartments is a mail box.

26. A method for the secure unattended delivery of goods to a tamper proof-enclosure, said tamper-proof enclosure operably controlled using a customer specified code, the method comprising the steps of:
placing an order for goods by a customer;
shipping said order by a delivery service to said customer;
using an Internet-based application to provide customer profile information to said delivery service, said customer profile information providing said delivery service with a means of obtaining said specified code; and
delivering said goods to said tamper-proof enclosure by said delivery service using said customer profile information.

27. The method of claim 26 wherein said step of delivering said goods is followed by the step of sending a status message from said tamper-proof enclosure to a routing hub.

28. The method of claim 27 wherein said step of sending a status message further includes the step of forwarding said status message to the customer via said routing hub.

29. The method of claim 27 wherein said step of sending a status message further includes the step of forwarding said status message to the delivery service via said routing hub.
